(19) United States
(12) Patent Application Publication
(10) Pub. No.: US 2013/0128370 A1
(43) Pub. Date: May 23, 2013

(54) DEVICE FOR THE CAPTURE OF SOLAR ENERGY WITH HIGH ANGULAR EFFICIENCY

(71) Applicants: Francesco Negrisolo, Sesto San Giovanni (IT); Maria Cristina Rosso, Torino (IT)

(72) Inventors: Francesco Negrisolo, Sesto San Giovanni (IT); Maria Cristina Rosso, Torino (IT)

(21) Appl. No.: 13/812,805

(22) PCT Filed: Jul. 18, 2011
(86) PCT No.: PCT/EP11/03577

§ 371 Date: Jan. 28, 2013

(30) Foreign Application Priority Data
Jul. 29, 2010 (IT) MI2010A001414

(51) Int. Cl. G02B 5/10

(52) U.S. Cl. CPC G02B 5/10
USPC 359/853

(57) ABSTRACT

The present invention relates to a device for the capture of solar energy with high angular efficiency which eliminates the use of the tracking systems normally present in the devices for the capture of solar radiation known to the state of the art, as well as systems of generation of electric or electromagnetic fields suitable for modifying some physical properties or the relative positions of some components of the system.

The present invention relates to a device for the capture of solar energy with high angular efficiency which eliminates the use of the tracking systems normally present in the devices for the capture of solar radiation known to the state of the art, made by means of electromechanical systems or systems of generation of electric or electromagnetic fields suitable for modifying some physical properties of some components of the system, or other known means.

The most widespread systems on the market for the capture of solar energy essentially provide profiles of concentration of the solar radiation characterised in that they have a parabolic geometry which, thanks to the geometric properties, is able to collect the radiation in a point known as focus. Said standard systems allow however only very limited acceptance angles and, in order to maintain the radiation concentrated in the geometric focus of the parabolas, use tracking systems which allow the reflecting or refracting surfaces to move in order to track the variation in slant of the sun's rays during the course of the day.

Some alternatives to the standard systems mentioned above are known to the state of the art. Said alternatives provide for the use of concentrators of solar radiation with complex shape able to obtain a focusing of said radiation in a point also for angles slightly different from the perpendicular to the device, without tracking systems.

The patent U.S. Pat. No. 7,412,976 describes a system essentially made up of a solar collector provided with an external reflector. The solar collector is made up of a housing in glass and the light reflector is placed outside of the housing. Since in order to be able to reach the absorber the angle formed by the radiation with the perpendicular to the reflector has to be close to zero, in order to be efficacious this device should be characterised by an extremely high size ratio between height and length (greater than 1) and, therefore, the acceptance angle of this device too is limited in the practical realisation by problems of bulk.

The patent U.S. Pat. No. 4,002,499 describes a device comprising a system able to concentrate the solar light on a target cell by means of primary and secondary reflector segments or elements. More particularly the light, by means of the primary segments, is focused on the target cell or reflected towards the secondary reflector segments. The secondary reflectors reflect the rays which arrive from the primary segments, focusing them in turn towards an exit aperture where the target cell is positioned, so that the latter is completely illuminated.

In this case too the useful acceptance angles are necessarily limited since an excessively high size ratio between height and width of the device would be necessary.

The patent U.S. Pat. No. 4,130,107 describes a system of capture of solar radiation comprising a reflecting side wall able to direct the incident radiation directly onto the absorber positioned at the exit aperture so as to focus the radiation.

As already is the case for the patents mentioned above, in this case too the ratio between the dimension of the height and the dimension of the width of the device has to be extremely high in order to increase in an appreciable manner the admissible range of the acceptance angle. In this case too, therefore, we are faced with a device with limited acceptance angle.

This obstacle appears to have been overcome by the devices described in the patent U.S. Pat. No. 6,958,868 and in the patent application WO 2008/003004, which provide for the use, in order to refract the rays of light towards the reflecting surface, of layers made up of specific materials whose optical properties, in particular relating to refraction, can be varied by means of the application of electric or electromagnetic fields traversing said materials. This idea enables non-use of any mechanical apparatus for movement while having an adequate height-width ratio, yet requires, in order to be applied, the use of further layers of conductor material which act as electrodes to which a difference of potential can be applied, increasing the complexity of the system and reducing the overall efficiency of the device due to the worse overall optical qualities of the multilayer system created in this way.

The object of the present invention is, therefore, that of making a highly efficient device able to capture solar energy also for angles of incidence of the solar radiation very different from 90° without providing any tracking system and with a size ratio between height and width of the device lower than one, with consequent reduction in the costs and overall dimensions.

A further object of the present invention is that of realising an invention which allows the aforementioned result to be obtained without requiring any electric or electromagnetic field to modify the optical properties of the components.

This object is achieved thanks to a device at least partially symmetrical in relation to at least one plane and comprising:

1. at least one concave reflecting surface with composite geometric profile, geometrically symmetrical in relation to a plane and whereof at least one section perpendicular to said plane is described by a curve of the fourth degree;

2. at least one transparent wall which can be traversed by the solar light, made up of several layers made up of different and transparent materials, preferably combined with at least one focuser having preferably a Fresnel profile or the like to modify the angle of incidence of the sun's rays, said wall being geometrically symmetrical in relation to said plane;

3. at least one absorber, geometrically symmetrical in relation to said plane, or in relation to an axis preferably lying in this plane, and whereof at least one section perpendicular to this plane does not define any complete circumference; said elements operating in optical combination one in relation to the other.

The presence of these three elements allows a system to be made which is able to capture solar radiation with high efficiency even for very high angles of incidence in relation to the perpendicular to the device, or to the plane of symmetry of the same or to a plane orthogonal to the refracting wall.

The composite wall, in combination with the focuser, is able to reduce the range of slant of the sun's rays which, if they fall on said wall with slants variable in a range of 90 degrees, for example from 0 to 90 degrees, in relation to a face of a plane which is preferably orthogonal to said plane of geometric symmetry of said wall, they exit the same with slant, in relation to the opposite face, comprised within a range reduced to at least 60 degrees with lower end greater than or equal to that of the previous range, for example from 30 to 90 degrees.

More precisely the transparent wall of the specific case, subsequently described for the purpose of a non-limiting example of the concepts later claimed, allows a range of slant comprised between 0 and 90 degrees to be reduced in a range of slant comprised between 30 and 90 degrees.

The procedure whereby the present device operates comprises at least the following steps:
the sun's rays fall on the transparent wall with a slant which can vary from 0 to 90 degrees in relation to a plane perpendicular to said plane of geometric symmetry of said wall, according to the slant of the sun's rays which is variable during the course of the day;
said rays exit from said wall with slants variable preferably from 30 to 90 degrees, according to the previous slant;
said rays are then reflected by the reflecting surface and fall subsequently on the absorber, remaining for all the slants in a zone, called zone of aggregation, always comprising at least one part of the absorber. The movement of the projection of this area of aggregation is sufficiently restricted to allow a height of said absorber smaller than the width of the device, obtaining the effect of concentration of energy. This enables the solar radiation to be collected efficiently without requiring any system of movement or of generation of electric or electromagnetic fields.

The indices of refraction of the layers of said wall are preferably increasing, passing from the outermost one to the innermost one, in relation to the concavity of the reflecting surface.

The absence of the tracking system and of any system for generation of electric and electromagnetic fields, together with a partial use of transparent polymeric materials in place of glass, allows a considerable reduction in the production costs.

These and further features of the present invention will be made clearer from the reading of the following detailed description relating to a preferred embodiment of the present invention to be considered by way of a non-limiting example of the more general concepts claimed.

The following description refers to the accompanying drawings, in which:

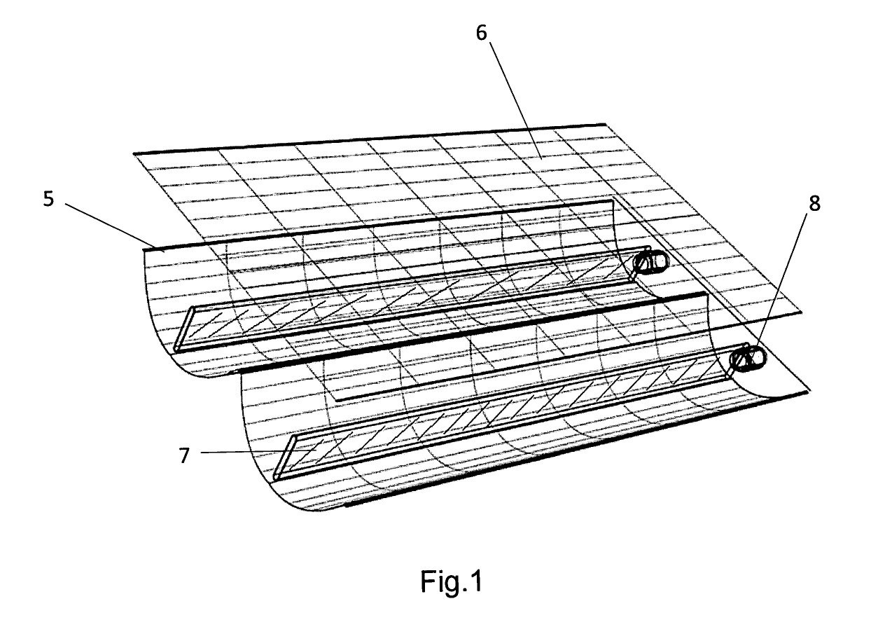

FIG. 1 is a perspective view of a system which combines in series two identical samples of the present device;

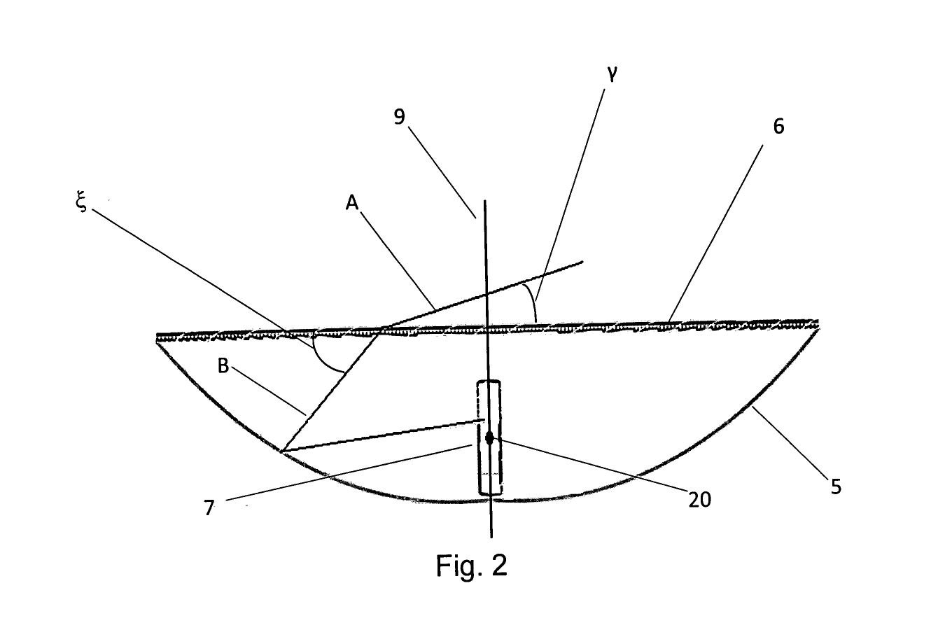

FIG. 2 is an example of the behaviour of the solar radiation characterised by a generic angle of incidence in relation to the transparent wall;

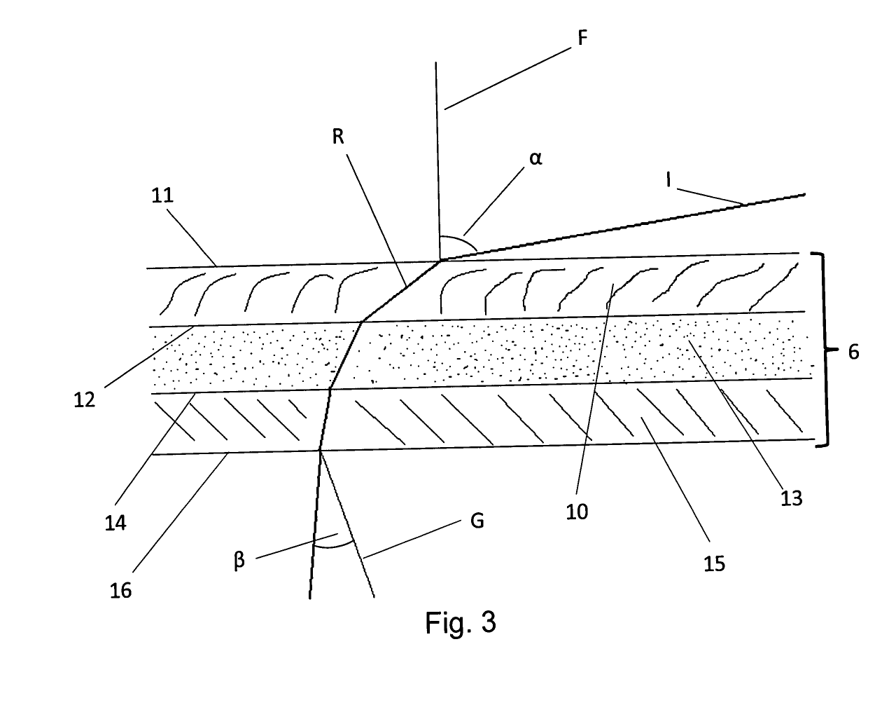

FIG. 3 is an example diagram of the structure of the multilayer wall traversed by the solar radiation;

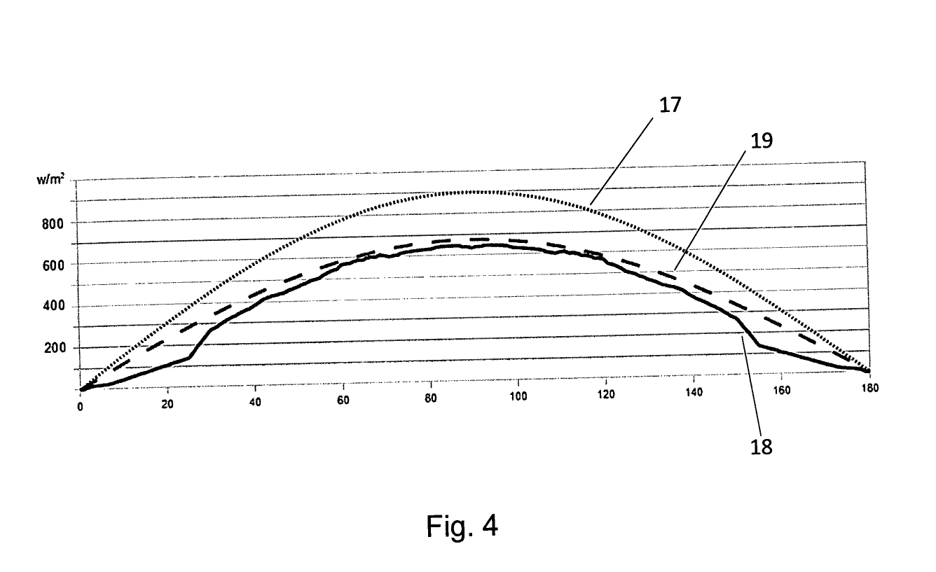

FIG. 4 represents the trend of the energy absorbed by a standard device known to the state of the art provided with a tracking system as a function of the angle of incidence of said radiation, the trend of the energy absorbed by the device of the present invention as a function of the angle of incidence of said radiation and the trend of the incident light energy as a function of the angle of incidence.

Referring to FIG. 1, the device of the present invention is made up mainly of:
at least one reflecting surface 5, geometrically symmetrical in relation to an axis;
at least one transparent wall 6, geometrically symmetrical in relation to said axis, which refracts the rays and directs them adequately towards said reflecting surface 5, made up of at least two layers whereof at least one is transparent and composed of a different material in relation to that of the other one, and combined with at least one focuser not shown in the drawing;
at least one absorber 7 which receives and absorbs said reflected rays, geometrically symmetrical both in relation to said axis and in relation to a further axis orthogonal to the previous one, the section of said absorber 7, considered perpendicular to said further axis, having at least one section with variable curving, and the plane containing said two axes being a plane of symmetry also for said transparent wall 6 and reflecting surface 5.

The solar radiation, traversing the transparent wall 6, is deviated towards the reflecting surface 5 and concentrated by the latter on the absorber 7. Said absorber 7 has therefore the function of absorbing the radiation and transferring the light energy to the subsequent stages of the process of conversion of the same. Said absorber 7 is preferably at least partially covered by a material with high absorption and low emissivity.

Said absorber 7 is placed at least partially on one side of said transparent wall 6 and is combined with at least one elongated conduit 8 aimed at the containing and/or conveying of a thermal carrier fluid and at supporting the absorber, said elongated conduit 8 being at least partially inside said absorber 7 and connected thereto.

Said elongated conduit 8 and absorber 7 are not in direct contact either with the transparent wall 6 or with the reflecting wall 5, in order to minimise the heat exchange between the various elements and prevent dispersions of energy or possible damage of the device.

The reflecting surface 5 is preferably shaped like a shell in whose concave part the absorber 7 is housed and the transparent wall 6 is preferably at least partially flat.

At least part of at least one section of the reflecting surface 5 along a plane perpendicular to one of the two axes of symmetry of the absorber 7, said axis being that which is orthogonal to the axis which is one of symmetry also for the reflecting surface and the wall, describes a curve of the fourth degree preferably symmetrical in relation to the plane containing the two abovementioned axes, and which can be defined mathematically by a function which ties a coordinate y which expresses the position along a first rectilinear axis lying in this plane containing the two axes of symmetry of the absorber 7, preferably directed along the direction of the axis of symmetry of wall 5 and reflecting surface 6, and a coordinate x which expresses the position along a second axis perpendicular to said first axis and intersecting the same, said second axis being preferably perpendicular also to said plane containing the two axes of symmetry of the absorber 7, such that the relation between said two coordinates, for the part with x greater than or equal to zero, can be expressed by an equation for setting to zero a polynomial of total degree four in the variables x and y, said equation being of the following type:

0=a·x²+b·|x|+c+d·|x·y|+e·y²+f·x⁴+g·|x³|

and, for the part with x smaller than or equal to zero, can be expressed by another equation for setting to zero another polynomial of total degree four in the variables x and y, which can also be equal to the previous one, said other equation being of the following type:

0=a₁·x²+b₁·|x|+c₁+d₁·|x·y|+e·y²+f·x⁴+g₁·|x³|

considering the origin of the variable x and of the variable y preferably in the point of intersection between said first and said second axis and considering the terms “a”, “a₁”, “b”, “b₁”, “c”, “c₁”, “d”, “d₁”, “e”, “f”, “g” and “g₁” as variable parameters, such that, preferably:
the ratio between “a” and “b” and between “a₁” and “b₁” is smaller than or equal to 0.166;
the ratio between “f” and “b” and between “f₁” and “b₁” is smaller than or equal to 0.066;

The latter conditions, literally, are the following:
the ratio between the multiplication coefficient of the literal part of the monomial of total degree two and partial degree two in relation to x and the multiplication coefficient of the literal part of the monomial of total degree one and partial degree one in relation to x is smaller than or equal to 0.166;
the ratio between the multiplication coefficient of the literal part of the monomial of total degree four and partial degree four in relation to x and the multiplication coefficient of the literal part of the monomial of total degree one and partial degree one in relation to x is smaller than or equal to 0.066.

The polynomial set equal to zero for both branches of the curve is total degree four, partial degree three in relation to the variable y and partial degree four in relation to the variable x.

In the aforementioned equations the literal parts of the following monomials are considered in absolute value:
monomial of total degree one and partial degree one in relation to x;
monomial of total degree two and, both in relation to x and in relation to y, partial degree one;
monomial of total degree three and partial degree three in relation to x.

FIG. 2 shows a section of the device along a plane containing the axis of symmetry 9 of wall 6 and reflecting surface 5, therefore placed midway of the length of said device. Both the plane of FIG. 2 and the one perpendicular thereto and containing the axis 9 are ones of symmetry for said reflecting surface 5 and wall 6, said planes therefore intersecting along said axis 9 which therefore is one of symmetry for both. The absorber 7 is instead symmetrical both in relation to said axis 9 and in relation to a further axis 20 orthogonal to the previous one, said further axis 20 being therefore orthogonal to the plane of the FIG. 2 and exiting therefrom.

The ratio between the dimension of the absorber 7 along said axis of symmetry 9 and the dimension transversal thereto of the wall 6 is less than 1 to allow an effect of concentration of the solar radiation.

Considering a generic sun's ray, said ray falls according to the direction A on the plane of the wall 6, which here is considered completely flat, with angle of slant γ in relation to said plane, which is perpendicular to both the abovementioned planes of symmetry of wall 6 and reflecting surface 5. When it leaves the wall 6, said sun's ray, following the refractions due to the passage through the interfaces between the various layers of said wall 6 and in the focuser, propagates along a direction B characterised by a different slant ε in relation to said plane and, following the interaction with said reflecting surface 5, reaches the absorber 7.

According to what was said previously, when the angle γ is 0 degrees, the angle ε is 30 degrees, whereas when the first of said angles is 90 degrees, the second one is also 90 degrees, since when said ray falls perpendicularly on said wall 6, its direction does not change due to the refraction, if this wall 6 is flat.

The direction of the axis of symmetry 9 of wall and reflecting surface coincides preferably with the direction of the axis of the aforesaid coordinate y, while the axis whereon the coordinate x is defined is preferably lying on the plane of the FIG. 2 and perpendicular to said axis 9.

Referring to FIG. 3, the section of the wall 6 comprises a first external layer 10, having index of refraction preferably different from that the air. Said layer 10 is bordered geometrically by a first surface 11, whereon the solar radiation falls and by a second surface 12, one of interface with the second layer 13, via which the solar radiation passes from the first of said layers to the other. In FIG. 3 the wall 6 is shown as if it were flat, just as the interfaces are shown flat, yet in actual fact both the wall and the surfaces of interface between the various layers inside the same can be characterised at least partially by a certain curving.

Said curving, in the figure, is taken into account by showing as slanted one in relation to the other the two directions F and G, orthogonal respectively to the surfaces 11 and 16 which geometrically border said wall, said directions being relative to the points of entry and exit respectively of the radiation from said wall 6. The angle a which the radiation forms with the direction F is generally different from the angle 13 which it forms with the direction G due both to said possible curving, albeit weak, and the phenomenon of refraction, which causes the change of slant of the ray of light, when the same traverses an interface between two different materials, in relation to the interface itself. The direction I corresponds to the direction of propagation of the radiation when it falls on the surface 10, while the direction R corresponds to the direction of propagation of the same radiation when it is passing over the layer 10, the change of slant in relation to the surface 11 being determined by the different indices of refraction of external air and material of the first layer 10.

In addition to the outermost layer 10, at least one other layer of different material is present: FIG. 3 shows a layer 13 geometrically bordered by the surfaces 12 and 14, and another layer 15 geometrically bordered by the surfaces 14 and 16.

In particular the thickness of the outermost layer, in relation to the concavity of the reflecting surface, is preferably smaller than the thickness of the innermost layers .

The various layers of materials described above are preferably characterised by an index of refraction which gradually increases from the outermost layer 10 to the innermost layer 15, in relation to the concavity of the reflecting surface 5, at the interface whereof the solar radiation undergoes a deviation of the angle which the direction of propagation of the radiation forms with the perpendicular to the interface.

The refractive effect of the transparent wall 6 as a whole will therefore be the resulting effect of all the interactions of the light with the interfaces of the various layers.

At least part of at least one section of at least one surface of interface between two layers of the wall 6, along a plane perpendicular to one of the two axes of symmetry of the absorber 7, said axis being the one orthogonal to the axis 9 which is one of symmetry also for the reflecting surface 5 and the wall 6, describes a curve which can be defined mathematically by a function which ties a coordinate y which expresses the position along a first rectilinear axis lying in the plane containing said two axes of symmetry of said absorber 7, preferably directed along the direction of the axis of symmetry 9 of wall 6 and reflecting surface 5, and a coordinate x which expresses the position along a second axis perpendicular to said first axis and intersecting the same, said second axis being preferably perpendicular also to said plane containing the two axes of symmetry of the absorber 7, such that the relation between said two coordinates, in a possible embodiment of the present device, can be expressed by an equation which graphically is represented by a linear combination of a parabola with an ellipsis, said equation being of the following type:

$$y = {f}_{1} \cdot ( a \cdot {x}^{2} + b \cdot \vert x \vert + c ) + {f}_{2} \cdot \sqrt{{d}^{2} - \frac{{x}^{2}}{{e}^{2}}}$$

considering the origin of the coordinate x and of the coordinate y preferably as the point of intersection between said first and second axis and considering the terms “f₁”, “f₂”, “a”, “b”, “c”, “d”, and “e” as variable parameters on the basis of the dimension of the absorber 7. In this case too the axis of the y is directed preferably along the direction of axis 9 of FIG. 2, while the axis of the x is preferably orthogonal to the previous one and lying on the plane of said FIG. 2.

The abovementioned equation is a function given by the sum of a polynomial in x of total degree two and of an irrational function of x.

In said polynomial the literal part of the monomial of degree one in relation to x is considered in absolute value, while the irrational function is a square root of a polynomial of total degree two in x.

The innermost surface 16 can be made with different geometric profile from the flat one shown in FIG. 3. In particular the surface 16 can be made with a profile made up at least in part of a broken line obtained from the sum of different segments oriented in a different manner in relation to the plane perpendicular to FIG. 2 and containing the axis 9, with a symmetrical trend in relation to the same plane which can be either periodic or characterised by a variable length of the respective segments as a function of the distance from said plane.

The layers 10, 13 and 15 are made preferably in materials having indices of refraction different one from the other.

Preferably at least one surface which borders at least one layer of the wall has a Fresnel profile or the like.

In particular the layer 10 may be preferably made in Teflon, silicone or in a composite matrix of Teflon and SiO2.

The layers 13 and 15 may be preferably made in CR39, PMMA, glass, Zeonex or polycarbonate.

Thanks to the deviation of the solar radiation performed by refraction at the passage of the radiation through the interfaces between the various layers and to the reflection on the reflecting surface 5 shaped as described above, the solar radiation itself is adequately concentrated on the absorber 7 during all the hours of light of the day.

In this way the elimination of the tracking systems is possible, i.e. it is possible to avoid the rotation of the unit of capturing to maintain the absorber in an optimal position in relation to the apparent position of the sun, and of the systems aimed at modifying the optical properties of the device by means of electric or electromagnetic fields to deviate adequately the solar radiation as the slant of the same varies.

Referring to the drawings, the radiation which traverses the transparent wall 6 and is reflected by the reflecting surface 5, concentrating then on the absorber 7, is aimed preferably at heating of a thermal carrier fluid contained in the tubular conduit 8 which is at least in part inside said absorber 3.

The thermal carrier fluid contained in the conduit 8 is, preferably, a mixture with specific heat greater than 0.5 calories/gram° C. and able to remain liquid, at ambient pressure, in a temperature range which varies according to the scope of application of the present invention.

In particular, in industrial applications, the temperature range will be between −40 degrees centigrade and 200 degrees centigrade, while in domestic applications the admitted temperature range will vary according to the different national legislations. In Italy, for example, the temperature range must be between −30 and 160 degrees centigrade.

In this way the solar radiation concentrated by the reflector 5 on the absorber 7 can raise the temperature of the thermal carrier fluid above 100 degrees centigrade without the heat transferred causing boiling at constant temperature of the thermal carrier fluid.

The device of the present invention comprises, moreover, a casing made in metal material or the like having the aim of connecting the wall 6 to the reflecting surface 5 and supporting the conduit 8. This casing may take on different configurations on the basis of the need of the user and preferably creates an airtight chamber where the residual pressure is below 1 atm and the residual gas present in the chamber is a gas with thermal capacity lower than that of air, typically argon or neon, to reduce the dispersion of the heat captured by the absorber 7. Said casing is not described further because it is part of the prior art.

Referring to FIG. 4, obtained following specific tests carried out, the trend of the energy of the incident radiation as a function of the angle of incidence of said radiation is represented by a dotted line 17, the trend of the energy absorbed by a standard device known to the state of the art and provided with a tracking system, as a function of the angle of incidence of said radiation, is represented by a dashed line 19 and the trend of the energy absorbed by the device of the present invention as a function of the angle of incidence of said radiation is represented by an unbroken line 18.

It can easily be noted that up to angles of high incidence (up to 50 degrees in relation to the zenith), the two devices are equivalent, the loss of efficiency of the device of the present invention occurs only for angles of incidence very different from the perpendicular (90°) corresponding to the hours of the day with lower energy intensity of the solar radiation.

Thanks to the combination of a reflecting surface 5 with geometric profile which is composite and symmetrical, a transparent wall 6 for modifying the angle of incidence of the sun's rays, an absorber 7 with non-circular section and preferably oval or shaped as an upside-down T, a device is thus made, able to capture solar energy also for angles of incidence of the solar radiation which are very high in relation to the perpendicular to the device, i.e. to the direction of the zenith without providing any tracking system and with a size ratio between height and width of the device lower than one.

Compositional variations of what is described above are possible, in any case coming within the scope of protection of the present patent according to what is expressed in the claims.

1-27. (canceled)

28. A device for the capture and the extraction of solar energy, comprising:
a wall made up of at least two layers made up of materials at least partially different, said wall being aimed at appropriately deviating the sun's rays through the phenomenon of refraction and being geometrically at least in part symmetrical in relation to at least one plane;
a reflecting surface at least in part concave with composite geometric profile, said reflecting surface being geometrically at least in part symmetrical in relation to at least said plane;
an absorber being at least partially geometrically symmetrical in relation to at least said plane;
said elements operating in optical combination one in relation to the other; wherein:
said reflecting surface has at least one section, perpendicular to said plane, described at least partially by a curve of the fourth degree; and
at least one section of said absorber, perpendicular to said plane, has at least one portion with variable curving.

29. The device for the capture and the extraction of solar energy according to claim 28, wherein said absorber is at least partially symmetrical in relation to at least one axis lying in this plane.

30. The device for the capture and the extraction of solar energy according to claim 28, wherein said wall is at least partially flat.

31. The device for the capture and the extraction of solar energy according to claim 28, wherein said curve of the fourth degree described by the at least one section of the reflecting surface can be defined mathematically by a function which ties a coordinate y which defines the position along a first axis lying in this plane and a coordinate x which defines the position along a second axis perpendicular to the previous one and intersecting the same, such that the relation between said two coordinates, for the part with x greater than or equal to zero, can be expressed by an equation for setting to zero a polynomial of total degree four in the variables x and y, and, for the part with x smaller than or equal to zero, can be expressed by another equation for setting to zero another polynomial of total degree four in the variables x and y, which can also be equal to the previous one, considering as origin of the variables x and y the point wherein said first and said second axis cross.

32. The device for the capture and the extraction of solar energy according to claim 31, wherein in each of said polynomials set equal to zero by means of said equations the literal parts of the following monomials are considered in absolute value:
monomial of total degree one and partial degree one in relation to x;
monomial of total degree two and partial degree one, both in relation to x and in relation to y;
monomial of total degree three and partial degree three in relation to x; and wherein, for both said polynomials,
the ratio between the multiplication coefficient of the literal part of the monomial of total degree two and partial degree two in relation to x and the multiplication coefficient of the literal part of the monomial of total degree one and partial degree one in relation to x is smaller than or equal to 0.166;
the ratio between the multiplication coefficient of the literal part of the monomial of total degree four and partial degree four in relation to x and the multiplication coefficient of the literal part of the monomial of total degree one and partial degree one in relation to x is smaller than or equal to 0.066.

33. The device for the capture and the extraction of solar energy according to claim 28, wherein said reflecting surface and wall are geometrically at least partially symmetrical in relation to at least one axis and said absorber is geometrically at least partially symmetrical in relation at least to said axis and to a further axis orthogonal to the previous one, at least one section of said absorber orthogonal to said further axis having at least one portion with variable curving.

34. The device for the capture and the extraction of solar energy according to claim 33, wherein:
said at least one section described at least in part by a curve of the fourth degree is considered perpendicular to an axis of geometric symmetry, relating to said at least one part of the absorber geometrically symmetrical in relation to at least two axes, said axis being the one orthogonal to the axis which is also of geometric symmetry for said parts geometrically symmetrical in relation to at least one axis of said reflecting surface and wall;
said plane whereon lies said first axis of the coordinate y contains said two axes of symmetry in relation whereto said at least one part of said absorber is geometrically symmetrical and this first axis is directed along the direction of the axis of geometric symmetry for said parts, geometrically symmetrical in relation to at least one axis of said reflecting surface and wall;
said second axis of the coordinate x is perpendicular to the plane containing said two axes in relation whereto said at least one part of said absorber is geometrically symmetrical;
said curve of the fourth degree is at least partially symmetrical in relation to this plane containing said two axes of symmetry of said at least one part of the absorber.

35. The device for the capture and the extraction of solar energy according to claim 28, wherein at least one of said at least two layers of said wall is at least partially transparent and composed of a material at least partially different from that of the other one.

36. The device for the capture and the extraction of solar energy according to claim 28, wherein the index of refraction of said two layers is increasing, passing from the outermost one to the innermost one in relation to said concave part of said reflecting surface.

37. The device for the capture and the extraction of solar energy according to claim 28, wherein at least one part of at least one section of at least one surface of interface between at least two layers of said wall, along a plane perpendicular to said plane in relation whereto said wall and reflecting surface are at least partially symmetrical, describes a curve which is the result of a linear combination of a parabola with an ellipsis.

38. The device for the capture and the extraction of solar energy according to claim 28, wherein said curve described by said at least one section of said interface surface can be defined mathematically by a function which ties a coordinate y which defines the position along a first rectilinear axis lying in this plane and a coordinate x which defines the position along a second axis perpendicular to the previous one and intersecting the same, such that the relation between said two coordinates can be expressed by an equation such that the variable y is the sum of a polynomial in x of total degree two and of an irrational function in x.

39. The device for the capture and the extraction of solar energy according to claim 38, wherein in said polynomial the absolute value of the literal part of the monomial of degree one in relation to x is considered, and in that the irrational function is a square root of a polynomial of total degree two in x and in that in said equation one or more parameters appear, variable on the basis of the size of the absorber.

40. The device for the capture and the extraction of solar energy according to claim 37, wherein:
said at least one section described at least in part by a curve resulting from the linear combination of a parabola with an ellipsis is considered perpendicular to an axis of geometric symmetry, relating to said at least one part of the absorber geometrically symmetrical in relation to at least two axes, said axis being the one orthogonal to the axis which is also of geometric symmetry for said parts, geometrically symmetrical in relation to at least one axis, of said reflecting surface and wall;
said plane whereon lies said first axis of coordinate y contains said two axes of symmetry in relation whereto said at least one part of said absorber is geometrically symmetrical and this first axis is directed along the direction of the axis of geometric symmetry for said geometrically symmetrical parts, in relation to at least one axis, of said reflecting surface and wall;
said second axis of coordinate x is perpendicular to the plane containing said two axes in relation whereto said at least one part of said absorber is geometrically symmetrical.

41. The device for the capture and the extraction of solar energy according to claim 28, wherein said wall is combined with at least one focuser.

42. The device for the capture and the extraction of solar energy according to claim 41, wherein said focuser is comparable to a focuser with Fresnel profile or the like.

43. The device for the capture and the extraction of solar energy according to claim 28, wherein the innermost surface bordering the innermost layer, in relation to said concave part of said reflecting surface, of said wall, is made with a profile at least partially made up of a broken line obtained from the sum of different segments oriented in a different manner in relation to said plane of geometric symmetry of said at least one symmetrical part of said wall, with a trend at least partially symmetrical in relation to the same plane which can be either periodic or characterised by a length of the respective segments as a function of the distance from said plane.

44. The device for the capture and the extraction of solar energy according to claim 28, wherein said absorber is at least partially covered by a material with high absorption and low emissivity, capable of absorbing the solar radiation and of transferring the heat to an appropriate fluid carrier.

45. The device for the capture and the extraction of solar energy according to claim 28, comprising at least one conduit at least partially inside said absorber and connected thereto, said conduit being aimed at conveying and/or containing a thermal carrier fluid.

46. The device for the capture and the extraction of solar energy according to claim 28, wherein the outermost layer, in relation to said concave part of said reflecting surface, of said wall has an index of refraction below 1.43 and is made up of Teflon and/or silicone or of a composite matrix of Teflon and SiO₂ or of a composite matrix of silicone and SiO₂ or the like.

47. The device for the capture and the extraction of solar energy according to claim 46, wherein the layers succeeding the outermost layer of said transparent wall have an index of refraction higher than 1.43 and are made up of glass, PMMA, polycarbonate, CR39, Zeonex or of a combination of these materials or the like.

48. The device for the capture and the extraction of solar energy according to claim 28, wherein at least one of the surfaces which geometrically border a single layer of said wall possesses a Fresnel profile or the like.

49. The device for the capture and the extraction of solar energy according to claim 28, wherein said reflecting surface and said wall are not in direct contact with the absorber in any point of the device.

50. The device for the capture and the extraction of solar energy according to claim 28, wherein inside said absorber a thermal carrier fluid circulates for the extraction of the heat from the device.

51. The device for the capture and the extraction of solar energy according to claim 28, wherein the wall is able to reduce the range of slant of the sun's rays, in such a way that, if said rays fail on said wall with slants variable in a range of 90 degrees, for example from 0 to 90 degrees, in relation to a face of a plane, which is preferably orthogonal to said plane of symmetry of said at least one geometrically symmetrical part of said wail 6, they exit from the same with slant in relation to the opposite face comprised within a range reduced to at least 60 degrees with lower end greater than or equal to that of the previous range, for example from 30 to 90 degrees.

52. The device for the capture and the extraction of solar energy according to claim 28, wherein the outermost layer, in relation to the concavity of the reflecting surface, of said wall, is thinner than the internal ones.

53. The device for the capture and the extraction of solar energy according to claim 28, comprising at least one appropriate casing in a metal material or the like which has the function of connecting the wall with the reflecting surface and of supporting said conduit, and also capable of creating an airtight chamber with pressure below one atmosphere and with residual gas with thermal capacity below that of air.

54. The device for the capture and the extraction of solar energy according to claim 28, wherein it operates according to a process comprising at least the following steps:
the suds rays fall on the wall with a slant which may vary from 0 to 90 degrees in relation to a plane perpendicular to said plane of symmetry of said at least one geometrically symmetrical part of said wall, according to the slant of the suds rays which is variable during the course of the day;
said rays exit from said wall with slants variable preferably from 30 to 90 degrees, according to the previous slant;
said rays are reflected by the reflecting surface and fall subsequently on the absorber, remaining for all the slants in a zone, called zone of aggregation, always comprising at least one part of the absorber, the movement of the projection of this zone of aggregation being sufficiently restricted to allow a height of said absorber smaller than the width of the device, obtaining the effect of concentration of energy.
